(19) United States
(12) Patent Application Publication
(10) Pub. No.: US 2026/0245354 A1
(43) Pub. Date: Aug. 20, 2026

(54) INFORMATION PROCESSING METHOD IN INFORMATION PROCESSING DEVICE, INFORMATION PROCESSING DEVICE, AND NON-TRANSITORY COMPUTER READABLE RECORDING MEDIUM

(71) Applicant: PANASONIC INTELLECTUAL PROPERTY MANAGEMENT CO., LTD., Osaka (JP)

(72) Inventors: Yasunori ISHII, Osaka (JP); Akihiro NODA, Osaka (JP); Shota ONISHI, Osaka (JP)

(21) Appl. No.: 19/646,996

(22) Filed: Apr. 14, 2026

Related U.S. Application Data
(63) Continuation of application No. PCT/JP2024/028905, filed on Aug. 13, 2024.

(30) Foreign Application Priority Data
Oct. 17, 2023 (JP) 2023-179139

(51) Int. Cl. G06V 10/94; G06V 10/26; G06V 10/764; G06V 20/70

(52) U.S. Cl. CPC G06V 10/945; G06V 10/26; G06V 10/764; G06V 20/70

(57) ABSTRACT

An information processing method includes: displaying target data and a label list including a plurality of labels for classifying the target data on a worker terminal; receiving selection of one of the plurality of labels; updating an input history in which a number of times of selection of each of the plurality of labels is recorded based on a selection result of the label; and updating a display order of the plurality of labels included in the label list according to a number of times of selection recorded in the input history each time display of the target data is switched to next target data.

### FIELD OF INVENTION

The present disclosure relates to a technique for supporting an operation of setting annotation data in target data.

### BACKGROUND ART

Conventionally, a system disclosed in Patent Literature 1 is known as a technique for simplifying annotation work of setting annotation data to target data. This system acquires a product image that is an image of a product to which a barcode is attached and a photographing time at which the product image is photographed, specifies a barcode scanned at a POS register at a time closest to the photographing time, and labels the product image with product identification information corresponding to the barcode. As a result, the product identification information as the annotation data can be set to the product image as the target data.

As described above, the system described in Patent Literature 1 is a technology on the premise that a barcode is included in target data. Therefore, in this system, annotation work on target data not including a barcode is not assumed, and further improvement is required to simplify the annotation work.

Patent Literature 1: JP 2021-033494 A

### SUMMARY OF THE INVENTION

The present disclosure has been made to solve such a problem, and an object of the present disclosure is to provide a technique for further simplifying annotation work.

An information processing method according to one aspect of the present disclosure is an information processing method in an information processing device, including: displaying target data and a label list including a plurality of labels for classifying the target data on a worker terminal; receiving selection of one of the plurality of labels; updating an input history in which a number of times of selection of each of the plurality of labels is recorded based on a selection result of the label; and updating a display order of the plurality of labels included in the label list according to a number of times of selection recorded in the input history each time display of the target data is switched to next target data.

According to the present disclosure, annotation work can be further simplified.

### BRIEF DESCRIPTION OF THE DRAWINGS

FIG. 1 is a block diagram illustrating an example of an annotation work support system according to a first embodiment of the present disclosure.

FIG. 2 is a diagram illustrating an example of an input history stored in an input history storage unit.

FIG. 3 is a flowchart illustrating an example of an overall image of processing of the annotation work support system according to the first embodiment.

FIG. 4 is a diagram for explaining processing of an image display order update unit according to the first embodiment.

FIG. 5 is a diagram illustrating a display device in which a first display image and a label list according to the first embodiment are displayed.

FIG. 6 is a diagram illustrating the first display image in which an annotation region is set.

FIG. 7 is a diagram for explaining processing of the input history update unit in a case of increasing the number of times of label selection.

FIG. 8 is a diagram illustrating a display device in which a second display image and a label list according to the first embodiment are displayed.

FIG. 9 is a diagram for explaining processing of the input history update unit in a case of increasing the number of times of label selection.

FIG. 10 is a diagram illustrating a display device in which a third display image and a label list according to the first embodiment are displayed.

FIG. 11 is a diagram for explaining processing of the input history update unit in a case of resetting the number of times of label selection.

FIG. 12 is a block diagram illustrating an example of an annotation work support system according to a second embodiment.

FIG. 13 is a flowchart illustrating an example of an overall image of processing of an annotation work support system according to the second embodiment.

FIG. 14 is a diagram for explaining processing of the input history update unit in a case of increasing the number of times of selection of similar labels.

FIG. 15 is a block diagram illustrating an example of an annotation work support system according to a third embodiment.

FIG. 16 is a flowchart illustrating an example of an overall image of processing of the annotation work support system according to the third embodiment.

FIG. 17 is a diagram illustrating a display device in which a first display image and a label list according to the third embodiment are displayed.

FIG. 18 is a diagram illustrating a display device in which a second display image and a label list according to the third embodiment are displayed.

FIG. 19 is a diagram for explaining processing of a region similarity evaluation unit.

FIG. 20 is a diagram for explaining processing of the input history update unit in a case where the number of times of selection of a label selected for a first annotation region is increased according to the number of third annotation regions.

FIG. 21 is a diagram illustrating a display device in which a third display image and a label list according to the third embodiment are displayed.

FIG. 22 is a diagram illustrating a display device in which a first display image and a label list according to a fourth embodiment are displayed.

### DETAILED DESCRIPTION

### Background of Present Disclosure

Conventionally, annotation work may be performed to generate learning data used when causing a learning model to perform machine learning. The annotation work is performed by, for example, the following procedure. First, target data such as image data and a label list including a label for classifying contents of the target data are displayed on a display device of a terminal operated by a worker. Next, the worker selects an appropriate label from the label list. For example, the worker operates a predetermined input device such as a mouse to select an appropriate label from the label list. Then, the label selected by the worker is set in the image data. Hereinafter, the annotation work is performed by repeating the same flow.

However, in recent years, the number of labels included in the label list is enormous, and a worker may be forced to select an appropriate label from, for example, hundreds of labels. In this case, the operation of searching for an appropriate label from the label list is complicated.

The present disclosure has been made in order to solve such a problem.

(1) An information processing method according to one aspect of the present disclosure is an information processing method in an information processing device, including: displaying target data and a label list including a plurality of labels for classifying the target data on a worker terminal; receiving selection of one of the plurality of labels; updating an input history in which a number of times of selection of each of the plurality of labels is recorded based on a selection result of the label; and updating a display order of the plurality of labels included in the label list according to a number of times of selection recorded in the input history each time display of the target data is switched to next target data.

According to this configuration, the display order of the plurality of labels can be updated so that the worker can easily select the label selected by the worker a large number of times, that is, the label having a high possibility of being selected by the worker. As a result, the worker can easily find an appropriate label from the label list. As a result, the annotation work is simplified.

(2) In the information processing method according to (1), the target data may be image data, the method further may include receiving an annotation instruction for the image data, and the label may be selected to classify an object included in an annotation region corresponding to the annotation instruction.

According to this configuration, the label can be set to the object included in the annotation region in the image data. As a result, it is possible to generate learning data with higher accuracy.

(3) In the information processing method according to (2), the target data may include first image data and second image data displayed after the first image data, the method further may include determining a third annotation region among one or more first annotation regions set in the first image data, the third annotation region having a region similarity exceeding a first threshold with respect to one or more second annotation regions set in the second image data, and the updating of the input history may include increasing a number of times of selection of a label selected for the one or more first annotation regions according to a number of the third annotation regions.

According to this configuration, when the region similarity between the first annotation region and the second annotation region is high, the number of times of selection of the label selected for the first annotation region increases. In this way, since the operation of selecting the label for the second annotation region is omitted, the annotation work is further simplified.

(4) In the information processing method according to (2) or (3), the annotation instruction can designate one or more annotation regions for one label, and the updating of the input history may include increasing the number of times of selection of the one label according to the number of the annotation regions designated for the one label.

According to this configuration, it is possible to efficiently increase the number of times of selection of a label selected for an annotation region that is highly likely to be included in image data at a high frequency. As a result, the display order of the plurality of labels is updated such that the labels are displayed at positions easily selected by the worker, and thus, it is possible to further simplify the work of searching for an appropriate label from the label list. As a result, the annotation work is further simplified.

(5) In the information processing method according to any one of (1) to (4), the updating of the input history may include increasing a number of times of selection of a selected label and a number of times of selection of a similar label similar to the selected label.

In a case where the target data includes a plurality of pieces of image data similar to each other, an object similar to an object included in a certain piece of image data may be included in another piece of image data. For example, in a case where a certain image data includes a bicycle, another image data may include a motorcycle. Here, according to the above configuration, when “bicycle” is selected as the label set in the annotation work for certain image data, the number of times of selection of the label of “bicycle” increases, and the number of times of selection of “motorcycle” which is a similar label of “bicycle” increases. As a result, the display order of the plurality of labels is updated such that not only the label of “bicycle” but also the label of “motorcycle” are displayed at positions where the worker can easily select. Therefore, when another image data includes a motorcycle, the worker can easily select the label of “motorcycle” in the annotation work for another image data. As a result, the annotation work is further simplified.

(6) In the information processing method according to (2), a display order of the target data may be determined in descending order of image similarity to target data displayed immediately before.

According to this configuration, there is a high possibility that similar objects are continuously included in the image data sequentially displayed on the worker terminal. Therefore, in the annotation work on the image data, the worker can designate the object and continuously select the same label. As described above, in the present disclosure, the display order of the plurality of labels is updated so that the worker can easily select a label selected by the worker a large number of times. Therefore, the same label is continuously displayed at a position where the worker can easily make selection. As a result, the annotation work is further simplified.

(7) The information processing method according to (6) may further include resetting the number of times of selection recorded in the input history when the image similarity is equal to or less than a second threshold.

When the image similarity between the image data (hereinafter, immediately preceding image data) displayed immediately before on the worker terminal and the image data (subsequent image data) displayed on the worker terminal subsequently to the immediately preceding image data is equal to or less than a second threshold, that is, when the image similarity between both the image data is low, it is unlikely that similar objects are continuously included in both the image data. In this case, there is a high possibility that the label selected by the worker in the annotation work for the image data after the subsequent image data is different from the label selected for the immediately preceding image data. Therefore, in this case, when the annotation work is performed on the image data after the subsequent image data, continuously displaying the label selected in the annotation work of the immediately preceding image data at a position where the worker can easily select the label might hinder the annotation work on the image data after the subsequent image data. According to the above configuration, when the image similarity is equal to or less than the second threshold, the number of times of selection recorded in the input history is reset. As a result, when the annotation work is performed on the image data after the subsequent image data, the label selected in the annotation work of the immediately preceding image data is suppressed from being continuously displayed at a position where the worker can easily make selection. As a result, the annotation work for the image data of the subsequent image data and the subsequent image data thereafter can be simplified.

(8) In the information processing method according to (2), the annotation region may be a polygon surrounding the object or a contour of the object.

According to this configuration, it is easy to designate the annotation region.

(9) In the information processing method according to any one of (1) to (8), the receiving of selection of the label may include inputting of voice data or text data.

According to this configuration, since it is possible to select a label by voice data or text data, it is not necessary for a worker to manually select an appropriate label. As a result, the annotation work becomes further simplified.

(10) The information processing method according to (9) may further include resetting, when the selection of the label based on the voice data or the text data is received, the number of times of selection recorded in the input history.

When the label is selected by voice data or text data, there is a high possibility that the label is displayed at a position where it is difficult for the worker to select. In other words, there is a high possibility that the display order of the current label is inappropriate. Here, according to the above configuration, when selection of a label is received by voice data or text data, the number of times of label selection is reset. That is, the display order of the labels is reset once. As a result, since the display order of the labels is easily updated, it is easy to update the display order of the labels to an appropriate order. As a result, the annotation work is further simplified.

(11) In the information processing method according to (2), the annotation instruction may be an instruction to designate a position of the object by a point, and the method may further include extracting the object from the image data based on the position of the point, and setting the annotation region to the object.

According to this configuration, since the annotation region is set by the worker designating the position of the object with a point, the annotation work is further simplified.

(12) An information processing device according to another aspect of the present disclosure includes: a display control unit that displays target data and a label list including a plurality of labels for classifying the target data on a worker terminal; a reception unit that receives selection of one of the plurality of labels; a history update unit that updates an input history in which a number of times of selection of each of the plurality of labels is recorded based on a selection result of the label; and an order update unit that updates a display order of the plurality of labels included in the label list according to a number of times of selection recorded in the input history each time display of the target data is switched to next target data.

According to this configuration, it is possible to provide an information processing device that executes the information processing method.

(13) An information processing program according to another aspect of the present disclosure causes a processor to execute: displaying target data and a label list including a plurality of labels for classifying the target data on a worker terminal; receiving selection of one of the plurality of labels; updating an input history in which a number of times of selection of each of the plurality of labels is recorded based on a selection result of the label; and updating a display order of the plurality of labels included in the label list according to a number of times of selection recorded in the input history each time display of the target data is switched to next target data.

According to this configuration, it is possible to provide an information processing program for executing the information processing method.

The present disclosure can be also implemented as an information processing system that is operated by such an information processing program. Further, it is needless to say that such a computer program can be distributed via a computer-readable non-transitory recording medium such as a CD-ROM or via a communication network such as the Internet.

Each of the embodiments described below illustrates a specific example of the present disclosure. Numerical values, shapes, components, steps, order of steps, and the like of the embodiments below are merely examples, and are not intended to limit the present disclosure. Further, a component not described in an independent claim representing a highest concept among components in the embodiments below is described as an optional component. In all the embodiments, respective contents can be combined.

### First Embodiment

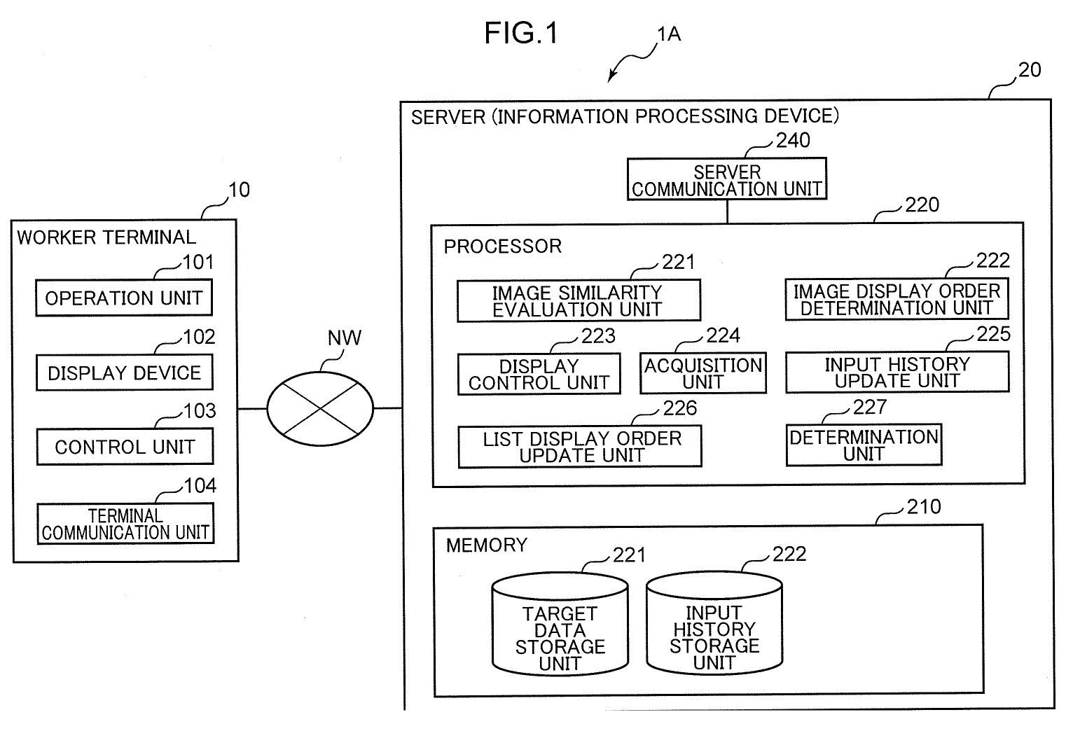

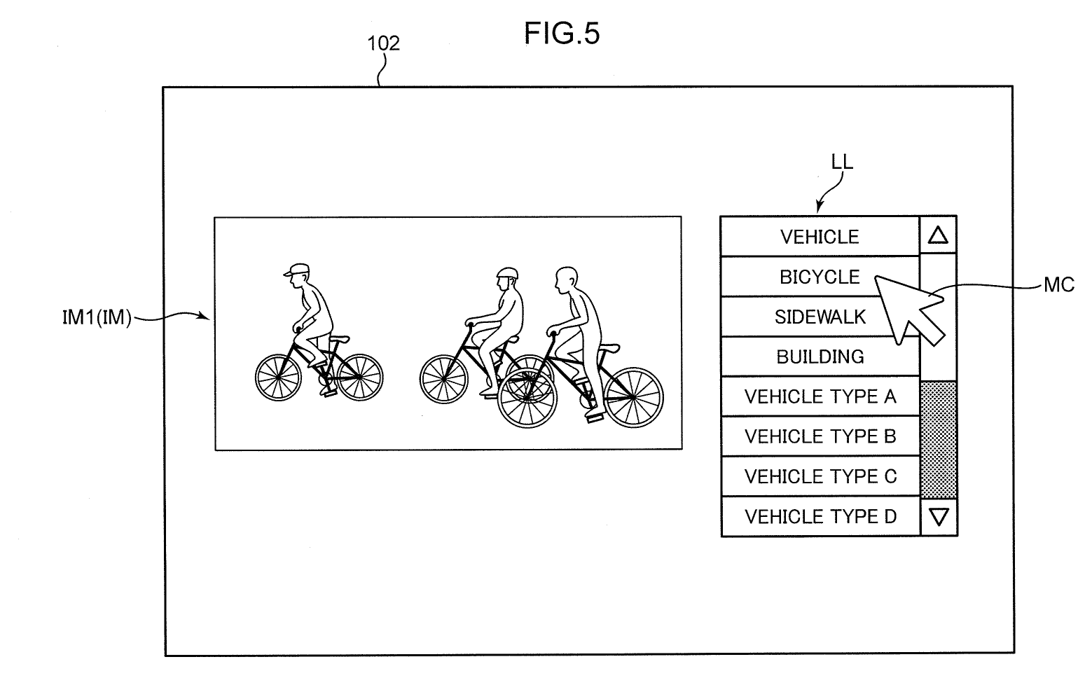

FIG. 1 is a block diagram illustrating an example of an annotation work support system 1A according to a first embodiment of the present disclosure. The annotation work support system 1A is a system that supports annotation work. The annotation work refers to a work of setting annotation data in target data. The target data is, for example, data related to an image, a moving image, a sound, and a sentence. The annotation data is information added to the target data. The annotation work is performed, for example, to generate learning data used when causing the learning model to perform machine learning. Hereinafter, an example in which the target data is image data IM (FIG. 5) will be described. In addition, in the first embodiment, an example in which the annotation data is a label for classifying an object included in the target data will be described.

As illustrated in FIG. 1, the annotation work support system 1A mainly includes a worker terminal 10, a network NW, and a server 20 (an example of an information processing device). The worker terminal 10 and the server 20 are configured to be able to communicate with each other via the network NW. The network NW includes, for example, a wide-area communication network including an Internet communication network and a mobile phone communication network.

The worker terminal 10 includes, for example, an information terminal such as a personal computer, a smartphone, or a tablet computer. The worker terminal 10 is operated by a worker who performs annotation work.

The worker terminal 10 includes an operation unit 101, a display device 102, a control unit 103, and a terminal communication unit 104. The operation unit 101 is an operation device such as a keyboard and a mouse. The display device 102 is, for example, a monitor such as a liquid crystal panel. The control unit 103 is, for example, an electric circuit such as a CPU, and performs overall control of the worker terminal 10. The terminal communication unit 104 is a communication circuit that connects the worker terminal 10 to the network NW.

The server 20 is a cloud server including one or more computers, for example. The server 20 includes a memory 210, a processor 220, and a server communication unit 240.

The memory 210 is a storage device capable of storing various types of information, such as a random access memory (RAM), a hard disk drive (HDD), a solid state drive (SSD), or a flash memory. The memory 210 includes a target data storage unit 211 and an input history storage unit 212.

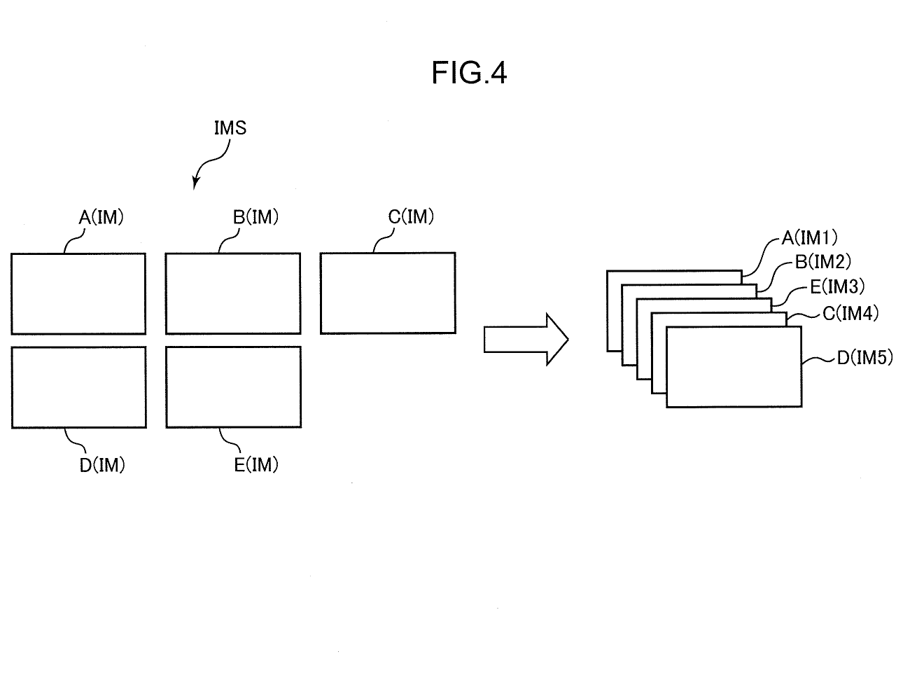

The target data storage unit 211 is a database that stores image data IM as an annotation work target. Specifically, the target data storage unit 211 according to the first embodiment stores an image data set IMS (FIG. 4) including a plurality of pieces of image data IM.

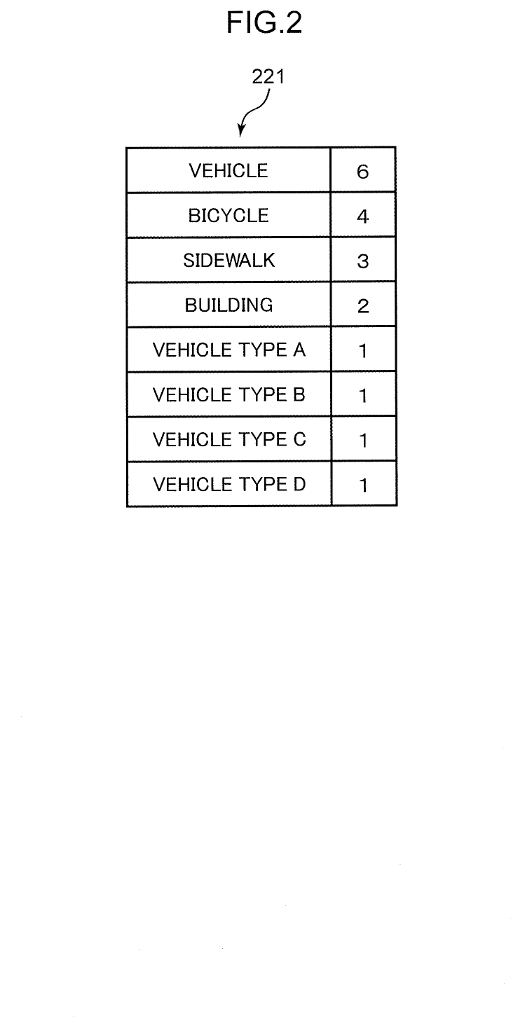

The input history storage unit 212 stores an input history. FIG. 2 is an example of an input history stored in the input history storage unit 212. As illustrated in FIG. 2, the number of times of selection of each label is recorded in the input history. For example, in the example illustrated in FIG. 2, it is recorded that the label of “car” has been selected six times, the label of “bicycle” has been selected four times, and the like in the annotation work so far.

Returning to FIG. 1, the processor 220 is, for example, an electric circuit such as a CPU. The processor 220 functions to include an image similarity evaluation unit 221, an image display order update unit 222, a display control unit 223, an acquisition unit 224, an input history update unit 225, a list display order update unit 226, and a determination unit 227 by executing a program stored in advance in the memory 210.

The image similarity evaluation unit 221 acquires the image data set IMS stored in the target data storage unit 211 of the memory 210, and evaluates the image similarity between the image data IM constituting the image data set IMS.

For example, the image similarity evaluation unit 221 evaluates the image similarity by calculating an error in the feature amount between the image data IM using a calculation method such as an absolute error, an L2 error, and a Cos distance. The image similarity evaluation unit 221 uses, for example, RGB values assigned to each pixel of each image data IM as the feature amount of the image data IM. In addition, the image similarity evaluation unit 221 may use, as the feature amount, a luminance value obtained by converting the RGB value, an edge feature obtained by performing edge detection processing on each piece of the image data IM, or the like. Note that the method of evaluating the image similarity is not limited to the above example. For example, the image similarity evaluation unit 221 may input each piece of image data IM to a neural network that has been subjected to machine learning in advance. Then, the image similarity evaluation unit 221 may acquire multidimensional vectors of the image data IM output from the neural network and evaluate the image similarity between the image data IM based on a vector error obtained by comparing the multidimensional vectors.

The image display order update unit 222 determines the display order when each piece of the image data IM is displayed on the display device 102 of the worker terminal 10 based on the image similarity between the pieces of the image data IM evaluated by the image similarity evaluation unit 221.

The display control unit 223 transmits a command for displaying the image data IM and a label list LL including a plurality of labels on the display device 102 to the worker terminal 10 through the server communication unit 240. The display control unit 223 may transmit information such as a program necessary for displaying the image data IM and the label list LL to the worker terminal 10 together with the above command as necessary.

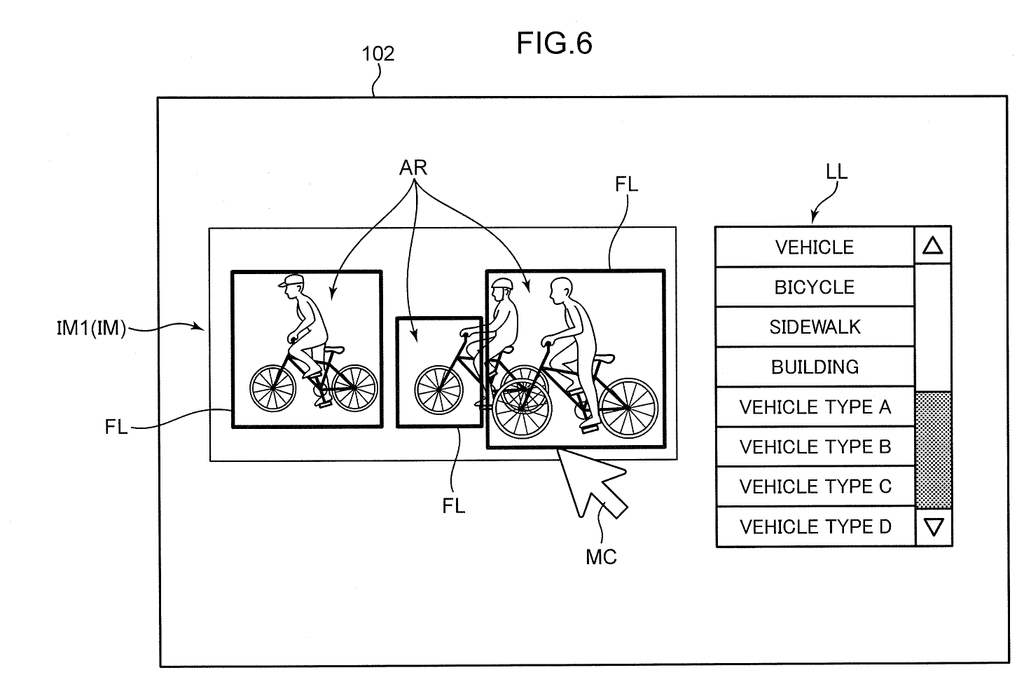

The acquisition unit 224 acquires label selection result information and annotation instruction information sent from the worker terminal 10 through the terminal communication unit 104 and the server communication unit 240. The label selection result information is information indicating which label the worker has selected from among a plurality of labels included in the label list LL in the current annotation work. The annotation instruction information is information indicating which region in the image data IM the worker has instructed as an annotation region AR (FIG. 6) in the current annotation work.

The determination unit 227 determines whether the annotation work has been completed. In addition, the determination unit 227 determines whether the image similarity between the image data IM displayed on the display device 102 in the previous annotation work and the image data IM displayed on the display device 102 in the current annotation work is equal to or less than a predetermined image similarity threshold (an example of the second threshold).

The input history update unit 225 refers to the label selection result information acquired by the acquisition unit 224 and updates the input history of the label selected by the worker in the current annotation work. Specifically, the number of times of selection of the label selected in the current annotation work is increased. Furthermore, the input history update unit 225 refers to the annotation instruction information acquired by the acquisition unit 224, and increases the number of times of selection of one label according to the number of annotation regions AR set for the one label. Further, when the determination unit 227 determines that the image similarity between the image data IM displayed in the previous annotation work and the image data IM displayed in the current annotation work is equal to or less than the image similarity threshold, the input history update unit 225 resets the number of times of selection of each label recorded in the input history storage unit 212.

The list display order update unit 226 updates the display order of the plurality of labels included in the label list LL according to the number of times of selection of each of the plurality of labels. Specifically, the list display order update unit 226 rearranges the display order of the plurality of labels in descending order, for example, according to the number of times of selection of each of the plurality of labels. In this way, a label having a large number of times of selection, that is, a label having a high possibility of being selected by the worker is displayed on the upper side of the label list LL. As a result, it is possible to suppress the occurrence of unnecessary work when the worker selects the label. The “unnecessary work” refers to, for example, a pull-down operation for displaying a label located below the label list LL or the like, a scroll bar operation for scrolling the label list to the lower layer of the label list LL, or the like. However, the method of rearranging the plurality of labels by the list display order update unit 226 is not limited thereto. If unnecessary work as described above can be reduced, the list display order update unit 226 may rearrange the display order of the plurality of labels in, for example, ascending order according to the number of times of selection of each of the plurality of labels. That is, the list display order update unit 226 updates the display order of the labels included in the label list LL so that unnecessary work does not occur.

The server communication unit 240 is a communication circuit for connecting the server 20 to the network NW.

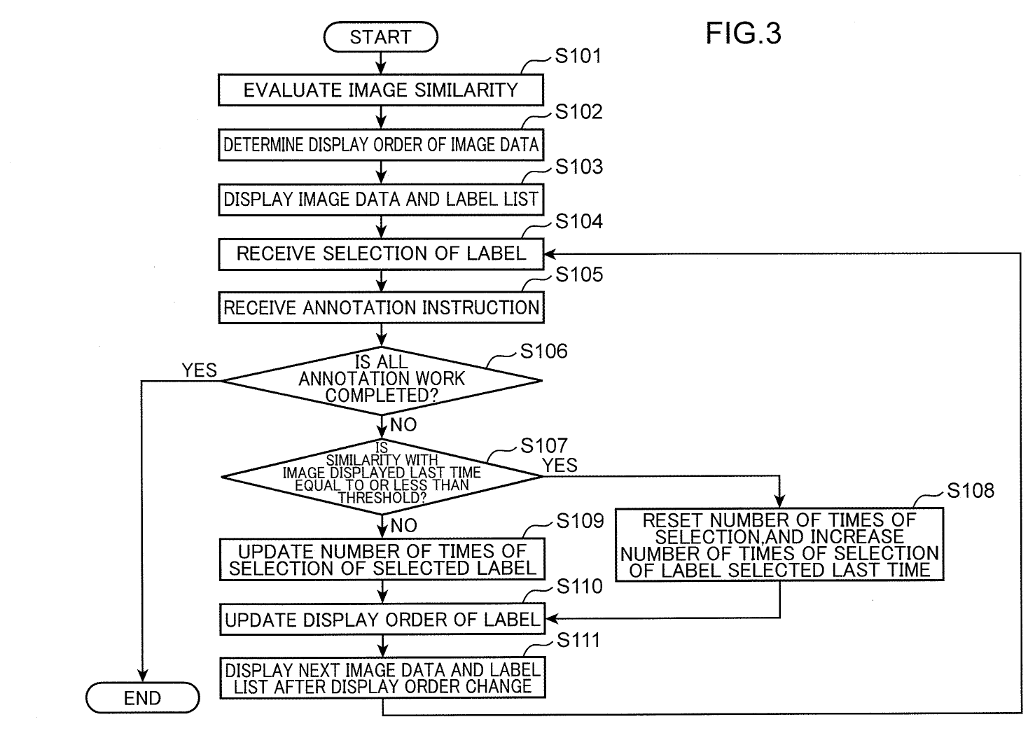

The processing of the annotation work support system 1A configured as described above will be described with reference to the flowchart of FIG. 3. FIG. 3 is a flowchart illustrating an example of an overall image of processing of the annotation work support system 1A according to the first embodiment.

In step S101, the image similarity evaluation unit 221 evaluates the image similarity between the image data IM.

In step S102, the image display order update unit 222 determines the display order of the image data IM in the display device 102 based on the image similarity evaluated by the image similarity evaluation unit 221. Hereinafter, processing of the image display order update unit 222 will be described with reference to FIG. 4 which is a diagram for explaining processing of the image display order update unit 222 according to the first embodiment. In addition, hereinafter, the image displayed first on the display device 102 is referred to as a first display image IM1, and the images displayed second, third, fourth, and fifth on the display device 102 are referred to as a second display image IM2, a third display image IM3, a fourth display image IM4, and a fifth display image IM5, respectively.

In step S102, the image display order update unit 222 first sets the image data IM evaluated by the image similarity evaluation unit 221 as the first display image IM1 and the second display image IM2 when the image similarity is the highest among all the image data IM included in the image data set IMS. Next, the image display order update unit 222 sets, as the third display image IM3, the image data IM having the highest image similarity to the second display image IM2 among the remaining image data IM excluding the first display image IM1. Similarly, the image display order update unit 222 sets, as the fourth display image IM4, the image data IM having the highest image similarity to the third display image IM3 among the remaining image data IM excluding the first display image IM1 and the second display image IM2. Hereinafter, the image display order update unit 222 repeats similar processing until the display order of all the image data IM is determined.

For example, as illustrated in FIG. 4, it is assumed that the image data set IMS includes images A, B, C, D, and E. In addition, it is assumed that the image similarity evaluation unit 221 evaluates that the image similarity between the image A and the image B is the highest among all the image data IM included in the image data set IMS. Furthermore, it is assumed that the image similarity evaluation unit 221 evaluates that the image data IM most similar to the image B except for the image A is the image E, and the image data IM most similar to the image E except for the image A and the image B is the image C. In this case, as illustrated in FIG. 4, the image display order update unit 222 sets the image A as the first display image IM1, the image B as the second display image IM2, the image E as the third display image IM3, the image C as the fourth display image IM4, and the image D as the fifth display image IM5. In this manner, the image display order update unit 222 rearranges the image data sets IMS such that the image data IM having the highest image similarity to the image data IM displayed immediately before on the display device 102 becomes the image data IM to be displayed next on the display device 102.

Returning to FIG. 3, in step S103, the display control unit 223 causes the display device 102 to display the image data IM and the label list LL. For example, the display control unit 223 displays, as the first display image IM1, the image data IM including three people riding a bicycle as illustrated in FIG. 5.

Next, in step S104, the control unit 103 of the worker terminal 10 receives the selection of the label. That is, in step S104, the worker is caused to execute label selection work. As illustrated in FIG. 5, here, the worker selects the label “bicycle”. In this case, the control unit 103 acquires the label selection result information indicating that the label “bicycle” has been selected. The label selection result information acquired by the control unit 103 is acquired by the acquisition unit 224 through the terminal communication unit 104 and the server communication unit 240.

Next, in step S105, the control unit 103 receives an annotation instruction for the image data IM from the worker. The control unit 103 that has received the annotation instruction sets the annotation region AR corresponding to the annotation instruction in the image data IM based on the annotation instruction. For example, the control unit 103 sets the annotation region AR as illustrated in FIG. 6 in the first display image IM1 based on the annotation instruction. FIG. 6 is a diagram illustrating the first display image IM1 in which the annotation region AR is set. Each region inside a quadrangular frame FL surrounding each of the three bicycles illustrated in FIG. 6 is the annotation region AR. Such setting of the annotation region AR is realized, for example, when the worker designates an upper left vertex portion and a lower right vertex portion of the annotation region AR in the annotation instruction. Specifically, the worker operates the mouse as the operation unit 101 to place a mouse cursor MC (FIG. 6) at the position of the upper left vertex of the annotation region AR. Then, the worker drags the mouse in the lower right direction while clicking (selecting) the mouse, and releases the click to designate the lower right vertex portion of the annotation region AR. Note that the annotation region AR may be set by a polygon other than a quadrangle, for example, a triangular or pentagonal frame. Furthermore, the annotation region AR may be set by a circular or elliptical frame. Furthermore, the setting of the annotation region AR may be realized by designating the outline of the object included in the annotation region AR. In this case, the worker may move the mouse cursor MC along the contour of the object, for example. The annotation instruction information acquired by the control unit 103 is acquired by the acquisition unit 224 through the terminal communication unit 104 and the server communication unit 240.

Next, in step S106, the determination unit 227 determines whether all the annotation work has been completed. Specifically, the determination unit 227 determines whether there remains image data IM on which annotation work has not been performed among the image data IM included in the image data set IMS. When all the annotation work has been completed (Yes in step S106), the processing of the annotation work support system 1A ends. When all the annotation work has not been completed (No in step S106), the process proceeds to step S107.

In step S107, the determination unit 227 determines whether the image similarity between the image data IM displayed on the display device 102 in the previous annotation work and the image data IM displayed on the display device 102 in the current annotation work is equal to or less than a predetermined image similarity threshold. When the image similarity is equal to or less than the image similarity threshold (Yes in step S107), the process proceeds to step S108. When the image similarity exceeds the image similarity threshold (No in step S107), the process proceeds to step S109. Note that, in a case where there is no comparison target as in the first display image IM1, the process proceeds to step S109. Step S108 will be described later.

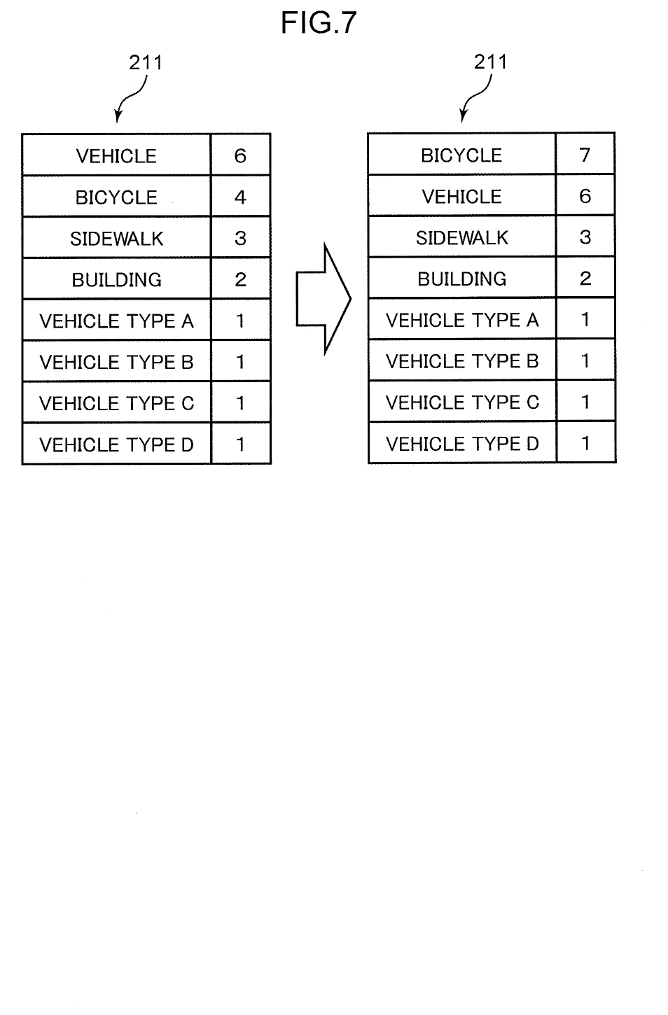

In step S109, the input history update unit 225 increases the number of times of selection of the label selected by the worker in the current annotation work based on the label selection result information. In addition, the input history update unit 225 grasps the number of annotation regions AR set for the label selected by the worker based on the annotation instruction information. Then, the input history update unit 225 increases the number of times of selection of the label selected by the worker according to the number of annotation regions AR. FIG. 7 is a diagram for explaining processing of the input history update unit 225 in a case where the number of times of label selection is increased. For example, in step S104, the label “bicycle” is selected, and in step S105, three annotation regions AR are designated for one label “bicycle”. In this case, as illustrated in FIG. 7, the input history update unit 225 increases the number of times of selection of the label of “bicycle” by 3 points.

In step S110, the list display order update unit 226 updates the display order of the plurality of labels included in the label list LL according to the number of times of selection of each of the plurality of labels. For example, as illustrated in FIG. 7, when the number of times of selection of the label of “bicycle” is the largest, the list display order update unit 226 rearranges the display order of the plurality of labels in the label list LL such that the label of “bicycle” is positioned at the top in the label list LL.

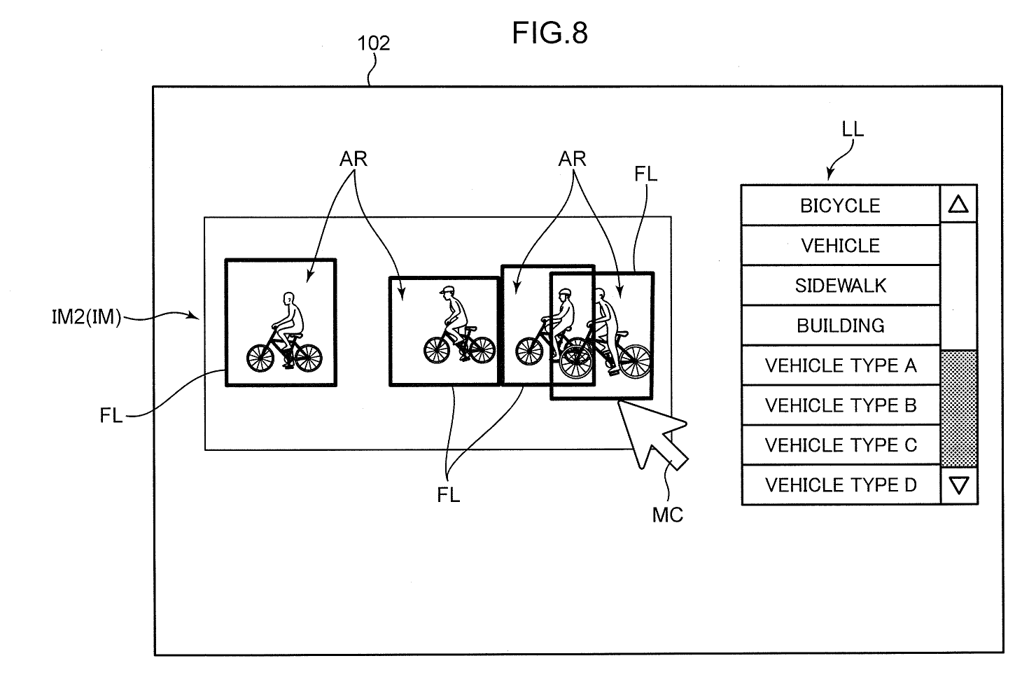

In step S111, the display control unit 223 transmits, to the worker terminal 10, a command to display the next image data IM and the label list LL after the display order change on the display device 102. For example, the display control unit 223 causes the display device 102 to display the second display image IM2 including four persons on a bicycle as illustrated in FIG. 8, and the label list LL in which the label of “bicycle” is displayed on the top by the processing of the list display order update unit 226.

Next, returning to step S104, the control unit 103 of the worker terminal 10 receives the selection of the label for the second display image IM2 from the worker. Here, it is assumed that the worker selects the label “bicycle” again.

In step S105, the control unit 103 receives an annotation instruction for the second display image IM2 from the worker, and sets the annotation region AR in the second display image IM2 based on the annotation instruction. As illustrated in FIG. 8, here, it is assumed that the control unit 103 sets each region inside four quadrangular frames FL superimposed on the second display image IM2 and surrounding each of the four bicycles as the annotation region AR based on the annotation instruction.

In step S106, the determination unit 227 again determines whether the annotation work has been completed. Here, it is assumed that the determination unit 227 determines that the annotation work is not completed.

In step S107, the determination unit 227 determines whether the image similarity between the first display image IM1 and the second display image IM2 is equal to or less than the image similarity threshold. Here, it is assumed that the determination unit 227 determines that the image similarity between the first display image IM1 and the second display image IM2 exceeds the image similarity threshold. In this case, the process proceeds to step S109.

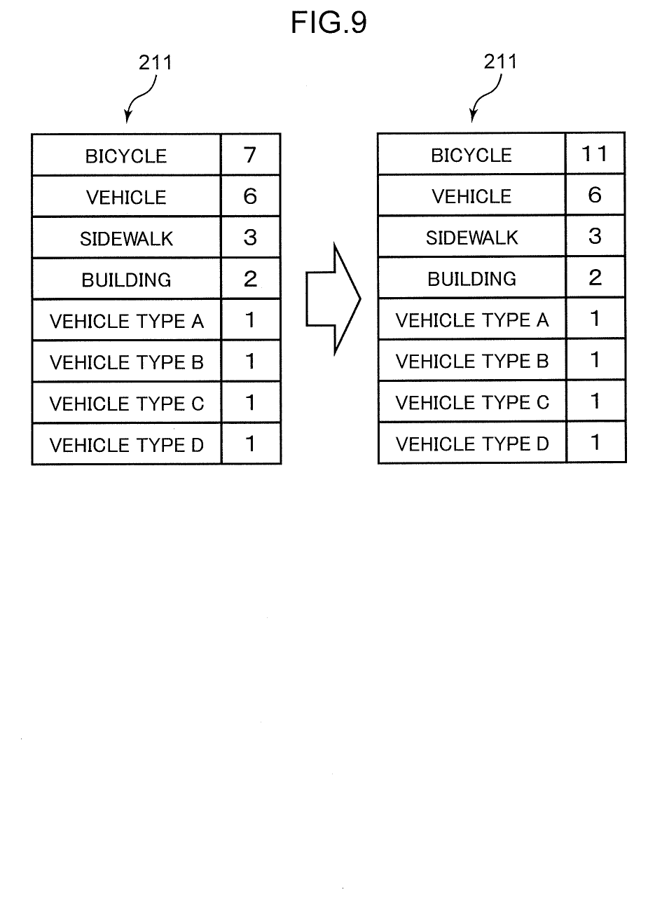

In step S109, the input history update unit 225 increases the number of times of selection of the label selected by the worker in the current annotation work. FIG. 9 is a diagram for explaining processing of the input history update unit 225 in a case where the number of times of label selection is increased. As described in step S104 and step S105, in the annotation work on the second display image IM2, four annotation regions AR are designated for one label “bicycle”. In this case, as illustrated in FIG. 9, the input history update unit 225 further increases the number of times of selection of the label of “bicycle” by 4 points.

In step S110, the list display order update unit 226 updates the display order of the plurality of labels included in the label list LL. As illustrated in FIG. 9, since the number of times of selection of the label of “bicycle” is the largest, the list display order update unit 226 rearranges the display orders of the plurality of labels in the label list LL such that the label of “bicycle” is positioned at the top in the label list LL.

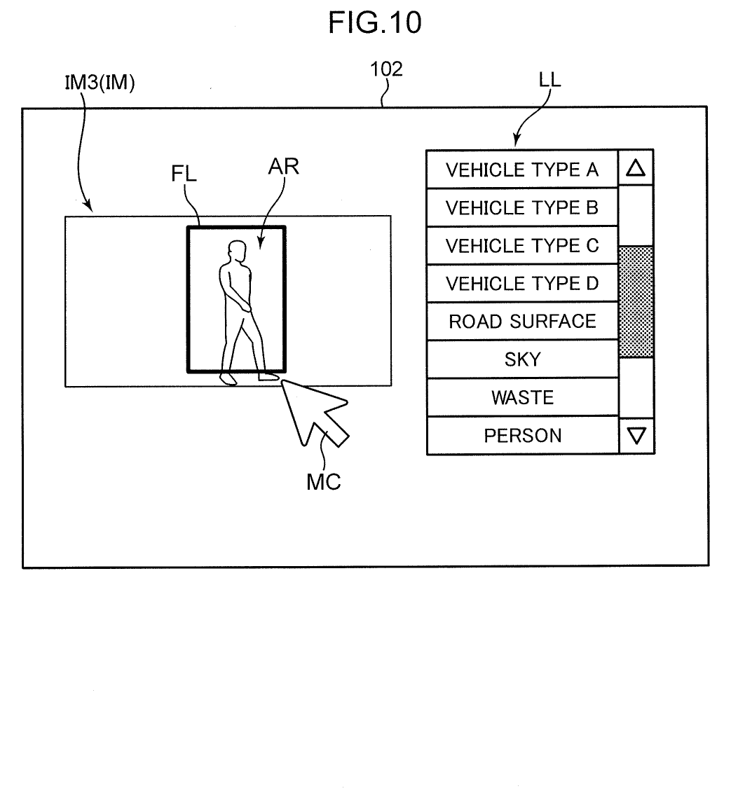

In step S111, the display control unit 223 transmits, to the worker terminal 10, a command for causing the display device 102 to display the third display image IM3 as the next image data IM and the label list LL after the display order change. Specifically, the display control unit 223 causes the display device 102 to display the third display image IM3 including one human as illustrated in FIG. 10.

Returning to step S104 again, the control unit 103 of the worker terminal 10 receives the selection of the label for the third display image IM3 from the worker. Here, as illustrated in FIG. 10, the label “person” is selected.

In step S105, the control unit 103 receives an annotation instruction for the third display image IM3 from the worker, and sets the annotation region AR in the third display image IM3 based on the annotation instruction. As illustrated in FIG. 10, here, the control unit 103 sets, as the annotation region AR, a region that is superimposed on the third display image IM3 and is inside one quadrangular frame FL surrounding one person based on the annotation instruction.

In step S106, the determination unit 227 again determines whether all the annotation work has been completed. Here, it is assumed that the determination unit 227 determines that not all the annotation work has been completed.

In step S107, the determination unit 227 determines whether the image similarity between the second display image IM2 and the third display image IM3 is equal to or less than the image similarity threshold. Here, it is assumed that the determination unit 227 determines that the image similarity between the second display image IM2 and the third display image IM3 is equal to or less than the image similarity threshold. In this case, the process proceeds to step S108.

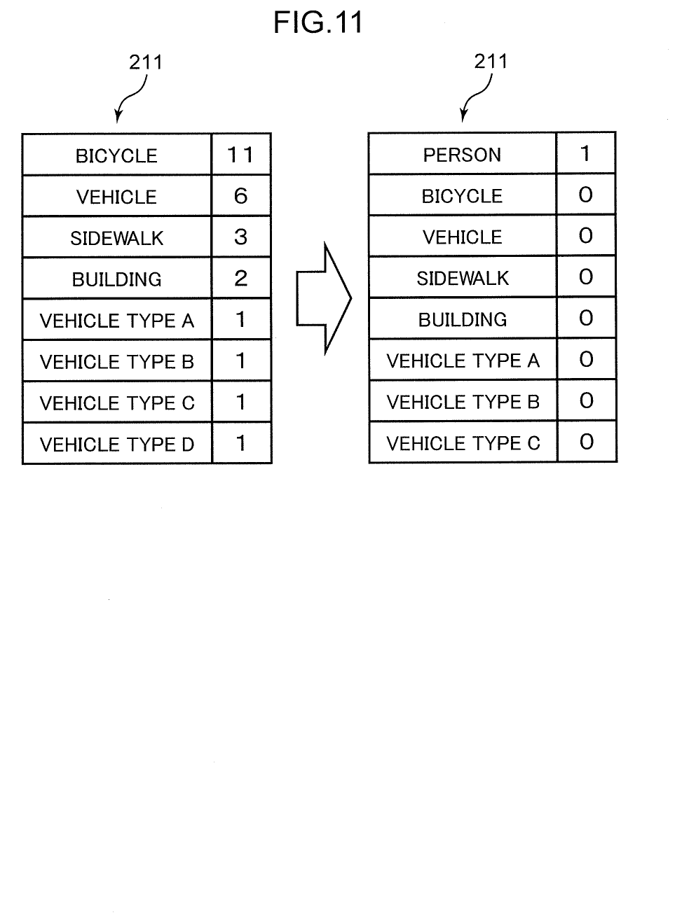

In step S108, the input history update unit 225 resets the number of times of selection of all the labels recorded in the input history storage unit 212. Then, after the number of times of selection of all the labels is reset, the number of times of selection of the label selected in the annotation work immediately before the reset is updated. FIG. 11 is a diagram for explaining processing of the input history update unit 225 in a case where the number of times of label selection is reset. As illustrated in FIG. 11, after updating the number of times of selection of all the labels to 0 point, the input history update unit 225 increases the number of times of selection of the label of “person” selected in the annotation work immediately before the reset by 1 point.

Then, in step S110, the list display order update unit 226 updates the display order of the plurality of labels included in the label list LL according to the number of times of selection of each of the plurality of labels. As illustrated in FIG. 11, here, the number of times of selection of the label of “person” is the largest. Therefore, the list display order update unit 226 rearranges the display order of the plurality of labels in the label list LL such that the label of “person” is positioned at the top in the label list LL. Note that the list display order update unit 226 may arrange labels other than the “person” label in a random display order.

Then, in step S111, the display control unit 223 transmits, to the worker terminal 10, a command for causing the display device 102 to display the fourth display image IM4 that is the next image data IM and the label list LL after the display order change. Hereinafter, in step S106, the same processing is repeated until the determination unit 227 determines that the annotation work has been completed for all the image data IM.

As described above, according to the annotation work support system 1A according to the first embodiment, the display order of the plurality of labels is rearranged so that the worker can easily select a label that is selected by the worker a large number of times in the annotation work, that is, a label that is highly likely to be selected by the worker. Accordingly, it is possible to easily find an appropriate label from the label list LL and select the appropriate label. As a result, the annotation work is simplified.

In addition, according to the above configuration, since the label having a high possibility of being selected by the worker is displayed at a position where the worker can easily select, it is possible to reduce label selection errors.

### Second Embodiment

In a second embodiment, when the number of times of selection of the label selected by the worker in the annotation work is increased, the number of times of selection of the similar label similar to the label selected by the worker is also increased. In the second embodiment, the same components as those in the first embodiment are denoted by the same reference numerals, and description thereof will be omitted. The same applies to each embodiment described later.

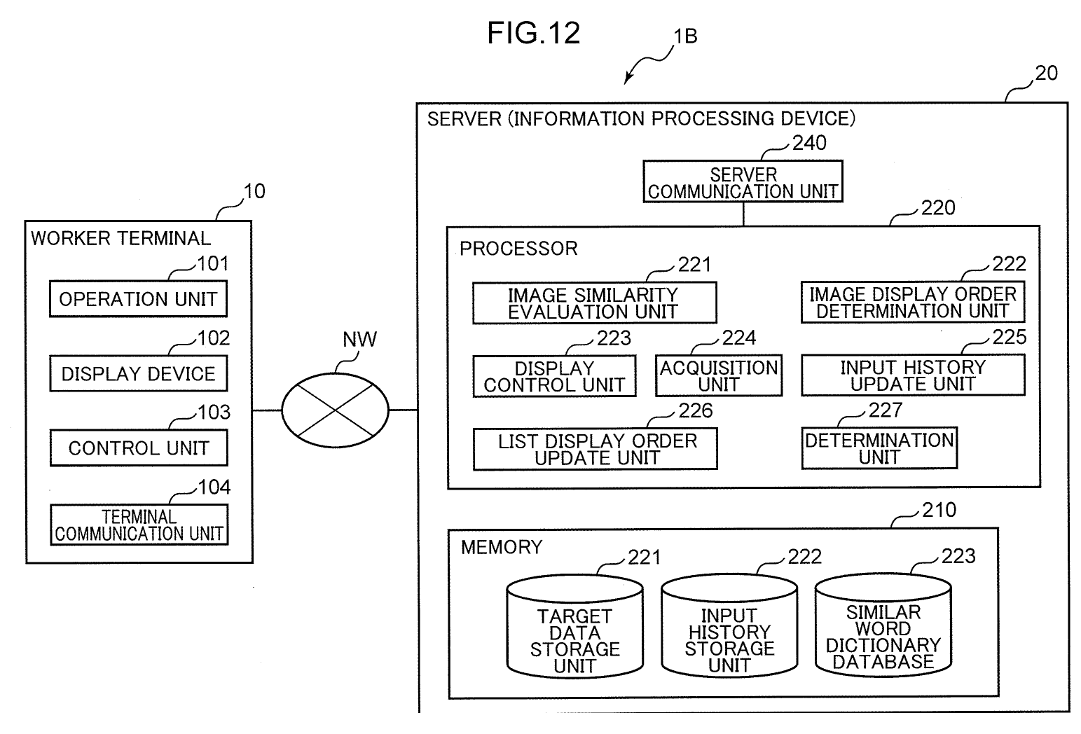

FIG. 12 is a block diagram illustrating an example of an annotation work support system 1B according to the second embodiment. As illustrated in FIG. 12, the annotation work support system 1B according to the second embodiment is different from the annotation work support system 1A according to the first embodiment in that the memory 210 includes a similar word dictionary database 213.

The similar word dictionary database 213 is a database in which similar words are recorded for a certain word. For example, for the word “bicycle”, existence of similar words such as “motorcycle” and “tricycle” is recorded in the similar word dictionary database 213. Similarly, the presence of similar words such as “bicycle” and “tricycle” for the word “motorcycle” is recorded in the similar word dictionary database 213.

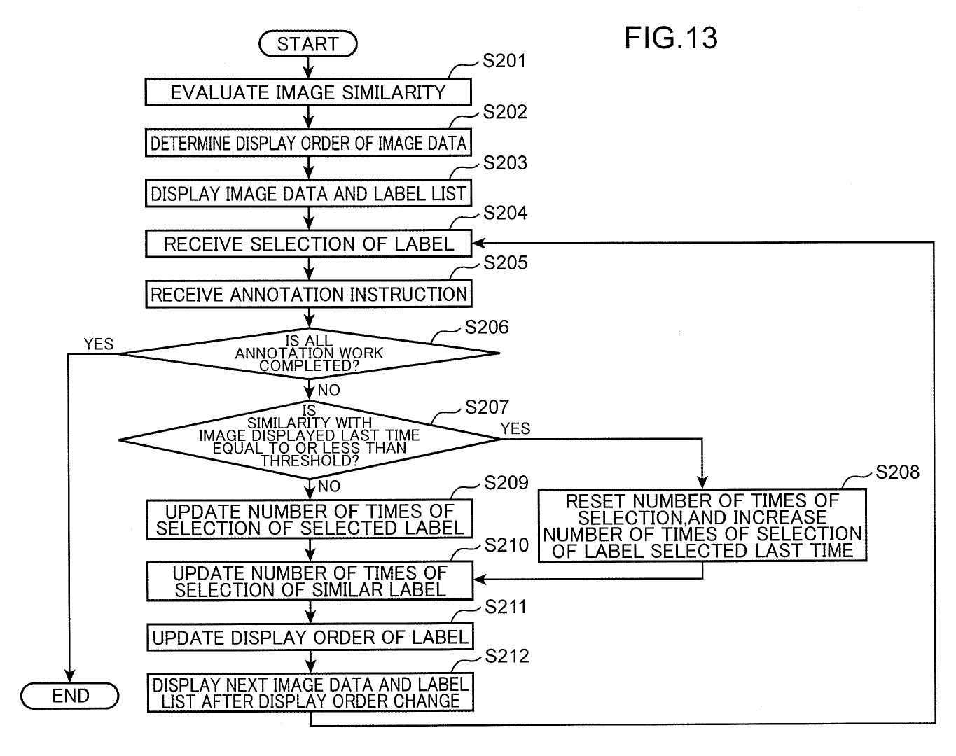

The processing of the annotation work support system 1B configured as described above will be described with reference to the flowchart in FIG. 13. FIG. 13 is a flowchart illustrating an example of an overall image of processing of the annotation work support system 1B according to the second embodiment.

Since the processing of steps S201 and S202 is similar to the processing of steps S101 and S102 described above, detailed description thereof will be omitted. That is, in the second embodiment, as in the first embodiment, the image display order update unit 222 determines the display order when each piece of image data IM is displayed on the display device 102 of the worker terminal 10 based on the image similarity evaluated by the image similarity evaluation unit 221. Furthermore, since the processing of steps S203 to S209 is similar to the processing of steps S103 to S109 described above, detailed description thereof will be omitted. As an example, here, in the processing of step S203, it is assumed that the image data IM as illustrated in FIG. 5 is displayed on the display device 102 as the first display image IM1. Furthermore, in the processing of steps S204 and S205, it is assumed that the worker selects the label “bicycle” and designates three annotation regions AR as illustrated in FIG. 6. Furthermore, in the processing of step S209, it is assumed that the input history update unit 225 increases the number of times of selection of the label of “bicycle” by 3 points as illustrated in FIG. 7.

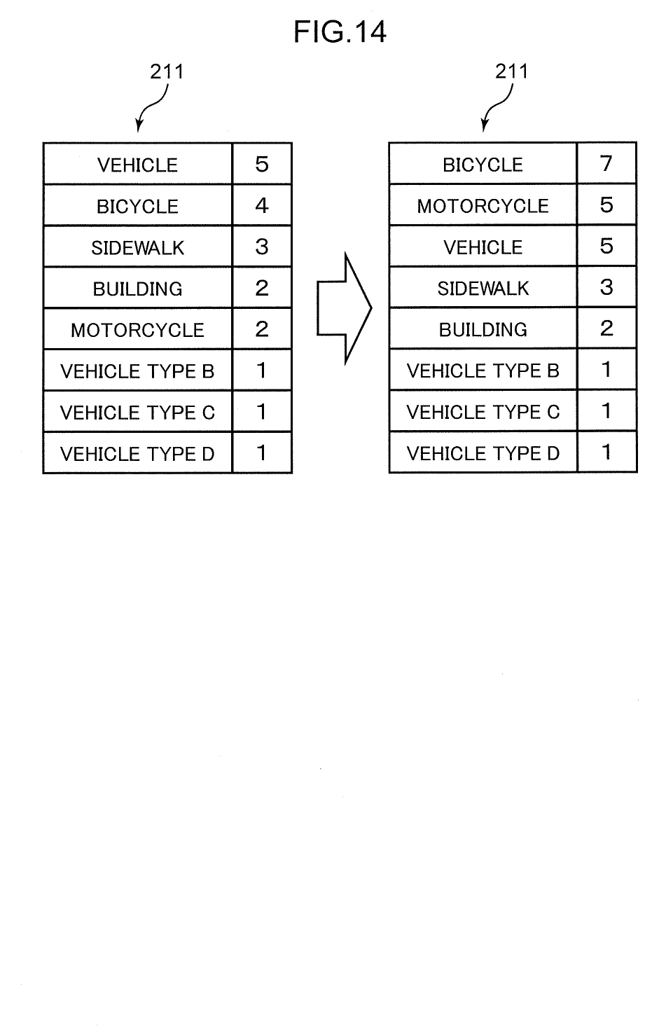

In step S210, the input history update unit 225 increases the number of times of selection of similar labels similar to the label selected by the worker in the current annotation work. Specifically, the input history update unit 225 first confirms whether a label selected by the worker in the current annotation work, that is, a word similar to “bicycle” exists in the similar word dictionary database 213. As described above, in the similar word dictionary database 213, it is recorded that words such as “motorcycle” and “tricycle” correspond to words similar to “bicycle”. Next, the input history update unit 225 confirms whether the labels of “motorcycle” and “tricycle” are included in the label list LL. Here, it is assumed that the label of “motorcycle” is included in the label list LL, while the label of “tricycle” is not included in the label list LL. In this case, the input history update unit 225 handles the label of “motorcycle” as a similar label. Then, the input history update unit 225 increases the number of times of selection for the similar label “motorcycle” by the same number as the increased number of times of selection for the label “bicycle”. FIG. 14 is a diagram for explaining processing of the input history update unit 225 in a case where the number of times of selection of similar labels is increased. As described above, in step S209, the input history update unit 225 increases the number of times of selection of the label of “bicycle” by 3 points. Therefore, as illustrated in FIG. 14, the input history update unit 225 increases the number of times of selection for the label of “motorcycle” which is the similar label by 3 points.

Since the processing in steps S211 and S212 is similar to the processing in steps S110 and S111, respectively, the description thereof will be omitted. Hereinafter, the processing described in the flow of FIG. 13 is repeated until the determination unit 227 determines that the annotation work for all the image data IM has been completed. For example, in a case where the image data IM indicating that a motorcycle is included is displayed on the display device 102, and the worker selects “motorcycle” as the label, the number of times of selection of the label of “bicycle” which is a similar label of “motorcycle” is increased together with the number of times of selection of the label of “motorcycle”.

As described above, according to the annotation work support system 1B of the second embodiment, when the worker selects the label of “bicycle” in a certain annotation work, the number of times of selection for “motorcycle” which is a similar label also increases. According to this configuration, the display order of the plurality of labels is updated such that not only “bicycle” but also the label of “motorcycle” are displayed at positions where the worker can easily select. Therefore, in another annotation work, when the image data IM including the object of the motorcycle is displayed, the worker can easily select the label “motorcycle”. As a result, the annotation work is further simplified. The configuration of the annotation work support system 1B is particularly suitable when the target data is constituted by a plurality of pieces of image data IM similar to each other as in the second embodiment. In other words, the configuration of the annotation work support system 1B is particularly suitable when the image data set IMS is configured such that there is a high possibility that an object similar to an object included in certain image data IM is included in another image data IM.

### Third Embodiment

In a third embodiment, a third annotation region AR3 is determined, and the processing of increasing the number of times of label selection according to the number of third annotation regions AR3 is performed.

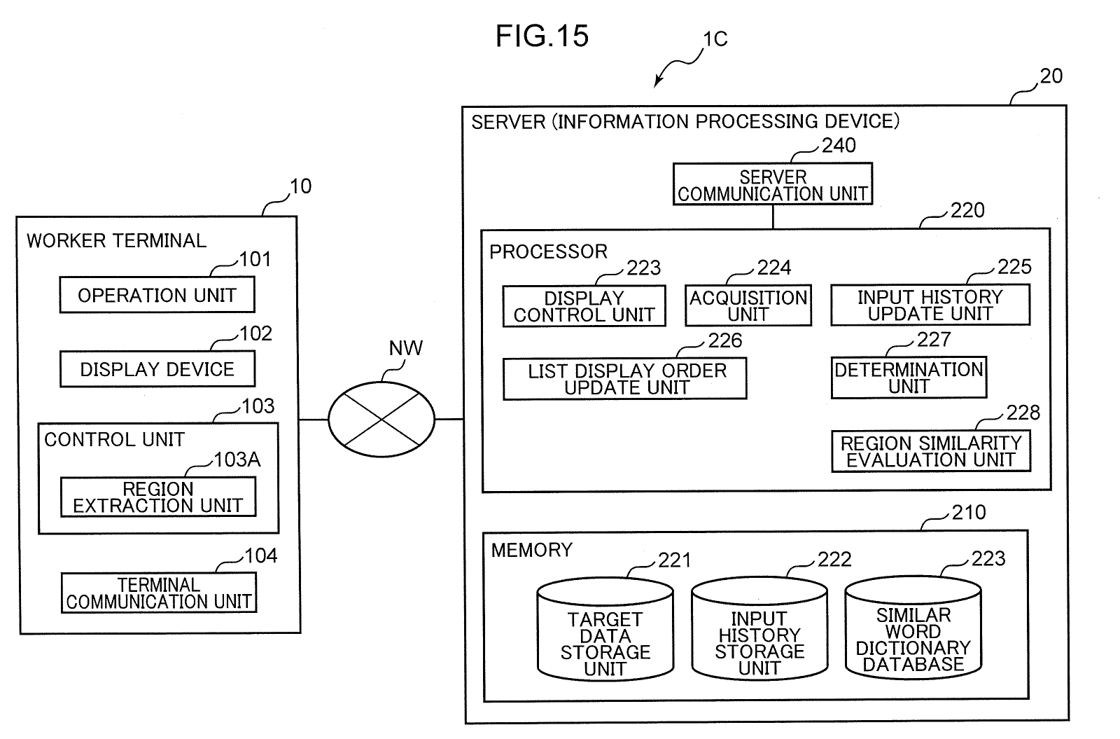

FIG. 15 is a block diagram illustrating an example of an annotation work support system 1C according to the third embodiment. As illustrated in FIG. 15, the annotation work support system 1C according to the third embodiment is different from the annotation work support system 1B according to the second embodiment in that the processor 220 includes a region similarity evaluation unit 228 and the control unit 103 includes a region extraction unit 103A. The annotation work support system 1C according to the third embodiment is different from the annotation work support system 1A and the annotation work support system 1B described above in that the annotation work support system 1C does not include the image similarity evaluation unit 221 and the image display order update unit 222.

When receiving an instruction to designate the position of the object included in the image data IM as a point from the worker, the region extraction unit 103A extracts the object from the image data IM based on the position of the point, and sets the annotation region AR in a region near the object.

The region similarity evaluation unit 228 determines the third annotation region AR3 based on the region similarity between a first annotation region AR1 and a second annotation region AR2. Specifically, the region similarity evaluation unit 228 evaluates the region similarity between one or more first annotation regions AR1 set in one image data IM and one or more second annotation regions AR2 set in another image data IM different from the one image data IM. Specifically, the region similarity evaluation unit 228 evaluates the region similarity by performing processing similar to the processing performed by the image similarity evaluation unit 221 described above. That is, the region similarity evaluation unit 228 evaluates the region similarity by calculating the error of the feature amount between the regions using a calculation method such as an absolute error, an L2 error, and a Cos distance. Then, the region similarity evaluation unit 228 determines the first annotation region AR1 whose region similarity exceeds a predetermined region similarity threshold (an example of the first threshold) as the third annotation region AR3.

The input history update unit 225 according to the third embodiment increases the number of times of selection of the label selected for the first annotation region AR1 according to the number of third annotation regions AR3.

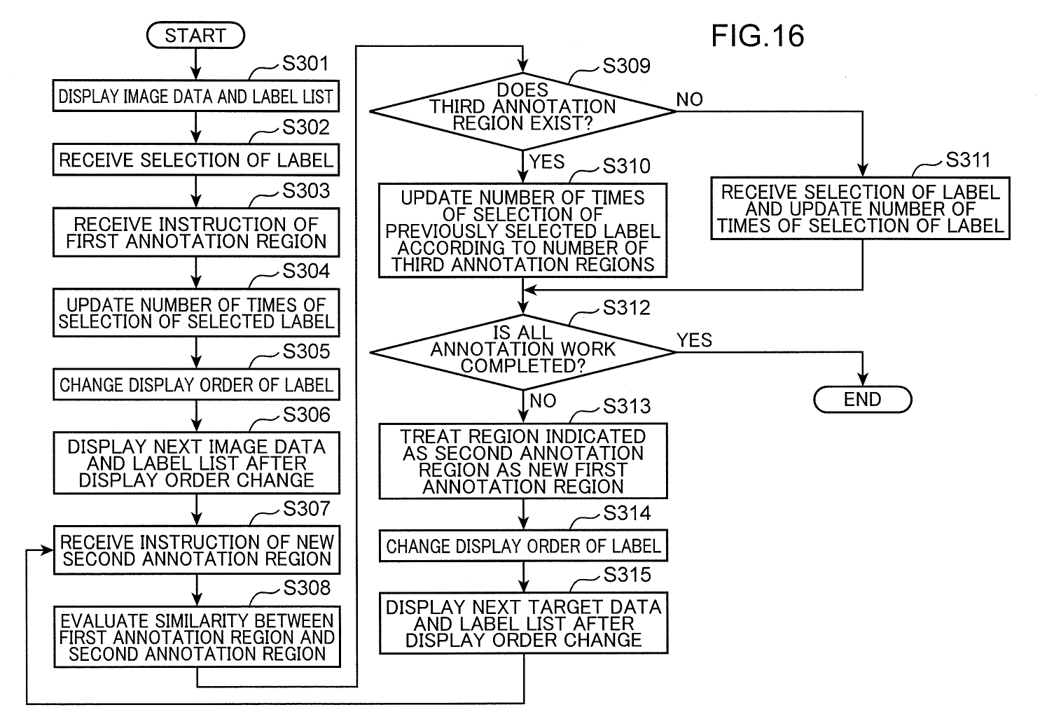

The processing of the annotation work support system 1C configured as described above will be described with reference to the flowchart in FIG. 16. FIG. 16 is a flowchart illustrating an example of an overall image of processing of the annotation work support system 1C according to the third embodiment. Note that, as described above, the annotation work support system 1C according to the third embodiment does not include the image similarity evaluation unit 221 and the image display order update unit 222. Therefore, in the third embodiment, the image data IM constituting the image data set IMS is displayed on the display device 102 in a random display order.

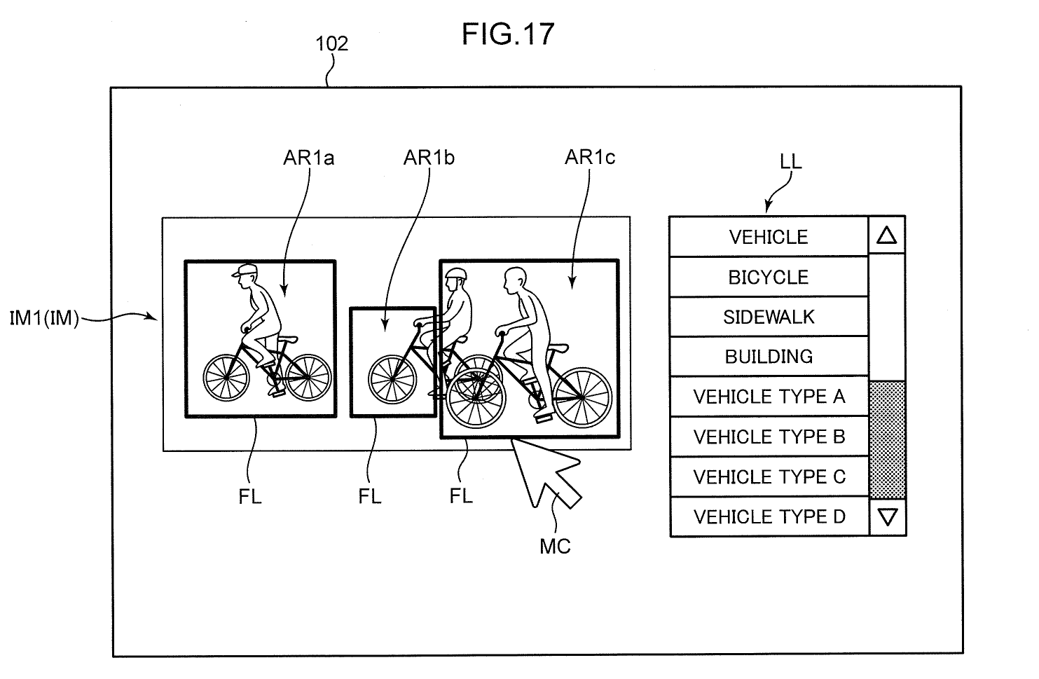

In step S301, the display control unit 223 causes the display device 102 to display the image data IM and the label list LL. For example, the display control unit 223 causes the display device 102 to display the first display image IM1 (an example of first image data) including three people riding bicycles as illustrated in FIG. 17 and a label list LL.

In step S302, the control unit 103 of the worker terminal 10 receives the selection of the label for the first display image IM1 from the worker. Here, it is assumed that the worker selects the label “bicycle”.

In step S303, the control unit 103 receives an annotation instruction for the first display image IM1 from the worker, and sets the annotation region AR in the first display image IM1 based on the annotation instruction. Here, as illustrated in FIG. 17, three annotation regions AR are set by three quadrangular frames FL surrounding three bicycles, respectively. Note that, in step S303, it is assumed that the annotation instruction is performed according to the mode in which the worker operates the mouse to designate the upper left vertex portion and the lower right vertex portion of each annotation region AR as described in step S105 of the first embodiment. The control unit 103 handles each of these three annotation regions AR as the first annotation region AR1. Hereinafter, each of the three first annotation regions AR1 illustrated in FIG. 17 is referred to as a first annotation region AR1a, a first annotation region AR1b, and a first annotation region AR1c.

In step S304, the input history update unit 225 increases the number of times of selection of the label selected by the worker according to the number of first annotation regions AR1. As described above, in step S303, three first annotation regions AR1 are designated for the label “bicycle”. Therefore, as illustrated in FIG. 14, the input history update unit 225 increases the number of times of selection of the label of “bicycle” by 3 points. At this time, as illustrated in FIG. 14, the input history update unit 225 may increase the number of times of selection of “motorcycle”, which is a similar label similar to the label “bicycle”, by 3 points.

In step S305, the list display order update unit 226 updates the display order of the plurality of labels included in the label list LL according to the number of times of selection of each of the plurality of labels.

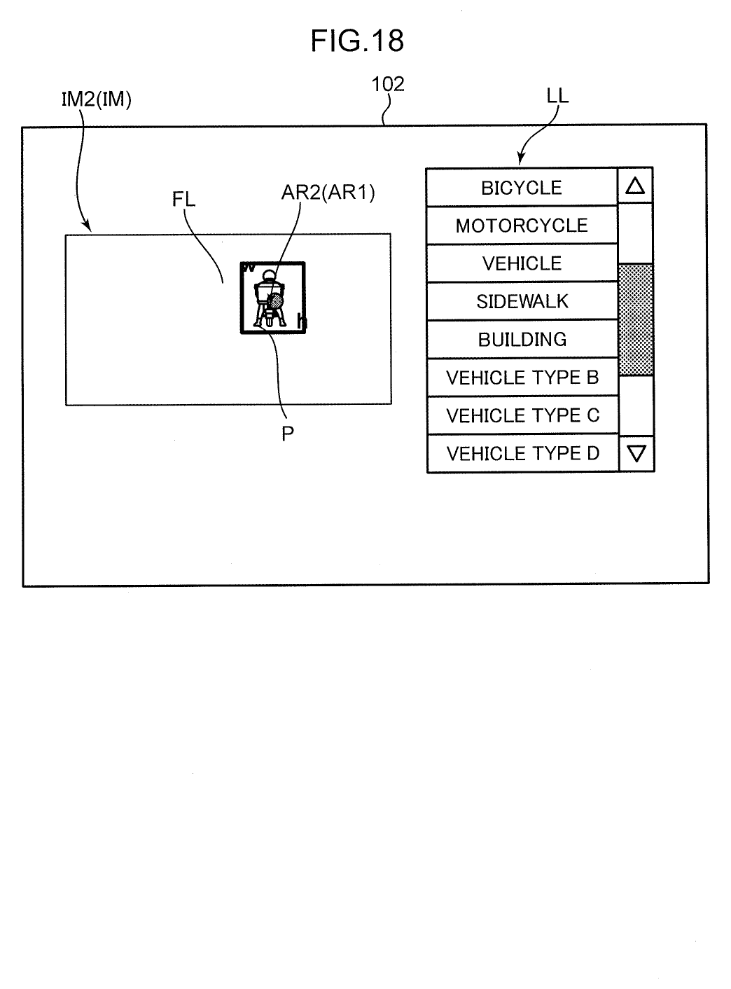

In step S306, the display control unit 223 transmits, to the worker terminal 10, a command to display the next image data IM and the label list LL after the display order change on the display device 102. For example, the display control unit 223 causes the display device 102 to display the image data IM including one person riding a motorcycle as illustrated in FIG. 18 as a second display image IM2 (an example of the second image data).

In step S307, the control unit 103 receives an annotation instruction for the second display image IM2 from the worker, and sets the annotation region AR in the second display image IM2 based on the annotation instruction. Here, as illustrated in FIG. 18, one annotation region AR is set by one quadrangular frame FL surrounding one motorcycle.

The instruction of the second annotation region AR2 in step S307 is realized by the worker specifying the position of the object included in the image data IM with a point. Specifically, the worker clicks with a mouse as the operation unit 101 while placing the mouse cursor MC on the portion indicated by the point P in FIG. 18. Hereinafter, such an operation is referred to as point designation. When the point designation is received, the region extraction unit 103A of the control unit 103 recognizes pixels around the point P designated by the worker and estimates the contour of the object designated by the worker. Such a technique is disclosed in, for example, Non-Patent Literature “Alexander Kirillov and 11 others, “Segment Anything”, [online], Meta AI Research, FAIR, [searched on Sep. 22, 2023], Internet <URL: https://arxiv.org/pdf/2304.02643.pdf>”. Then, as illustrated in FIG. 18, the region extraction unit 103A surrounds a region in the vicinity of the contour of the object designated by the worker by a quadrangular frame FL constituted by a pair of horizontal lines extending in the width direction w and a pair of vertical lines extending in the height direction h, and extracts the region. The control unit 103 sets the region extracted in this way as the second annotation region AR2. However, the method of instructing the second annotation region AR2 in step S307 is not limited thereto, and the second annotation region AR2 may be instructed by a method similar to the method described in step S105 of the first embodiment.

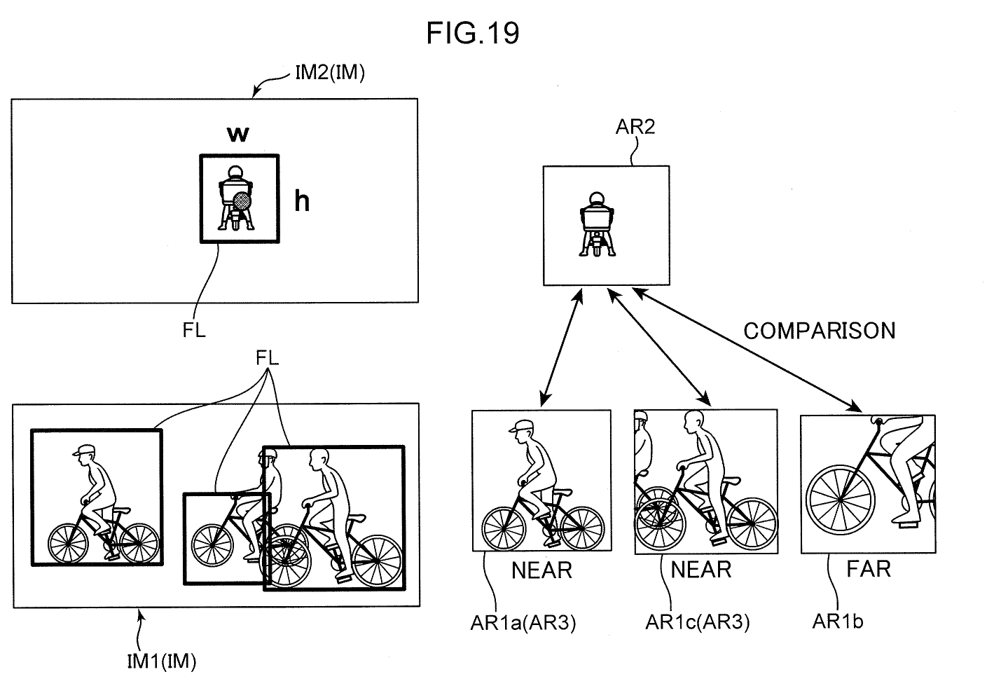

Returning to FIG. 16, in step S308, the region similarity evaluation unit 228 evaluates the region similarity between the first annotation region AR1 and the second annotation region AR2. The processing of the region similarity evaluation unit 228 will be described in detail with reference to FIG. 19. FIG. 19 illustrates three first annotation regions AR1, AR1b, and AR1c set in the processing of step S303 and one second annotation region AR2 set in the processing of step S307. As illustrated in FIG. 19, the region similarity evaluation unit 228 compares the second annotation region AR2 with each of the first annotation regions AR1, and evaluates the region similarity between the second annotation region AR2 and each of the first annotation regions AR1. Then, the region similarity evaluation unit 228 determines, as the third annotation region AR3, the first annotation region AR1 in which the region similarity to the second annotation region AR2 exceeds a region similarity threshold. When there are a plurality of second annotation regions AR2, the region similarity evaluation unit 228 evaluates the region similarity between each of the plurality of second annotation regions AR2 and each of the plurality of first annotation regions AR1.

Returning to FIG. 16, in step S309, the determination unit 227 determines whether the third annotation region AR3 exists. When the third annotation region AR3 exists (Yes in step S309), the process proceeds to step S310. When the third annotation region AR3 does not exist, the process proceeds to step S311.

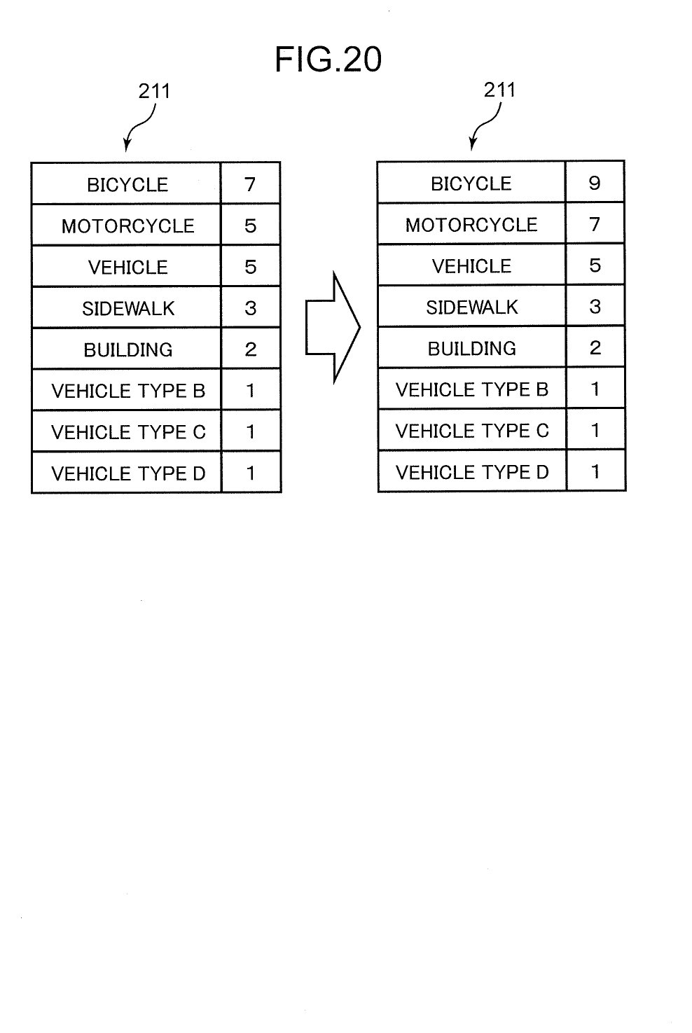

In step S310, the input history update unit 225 increases the number of times of selection of the label set in the first annotation region AR1 according to the number of third annotation regions AR3. As an example, it is assumed that the region similarity evaluation unit 228 evaluates that the region similarity of the first annotation region AR1a and the first annotation region AR1c to the second annotation region AR2 exceeds the region similarity threshold. That is, it is assumed that the region similarity evaluation unit 228 determines the first annotation region AR1a and the first annotation region AR1c as the third annotation region AR3. FIG. 20 is a diagram for explaining the processing of the input history update unit 225 in a case where the number of times of selection of a label selected for the first annotation region AR1 is increased according to the number of third annotation regions AR3. As described above, the label “bicycle” is selected as the label set to the first annotation region AR1. Here, there are two third annotation regions AR3. In this case, as illustrated in FIG. 20, the input history update unit 225 increases the number of times of selection of the label of “bicycle” by 2 points. At this time, the input history update unit 225 may increase the number of times of selection of the label of “motorcycle”, which is a similar label similar to “bicycle”, by 2 points.

Returning to FIG. 16, in step S311, the control unit 103 receives the selection of the label for the second annotation region AR2. That is, when the third annotation region AR3 does not exist, the control unit 103 causes the worker to select the label to be set in the second annotation region AR2. Here, it is assumed that the worker selects the label “motorcycle” as the label to be set in the second annotation region AR2. As described above, since one second annotation region AR2 is set in step S307, the input history update unit 225 increases the number of times of selection of the label “motorcycle” by 1 point. At this time, the input history update unit 225 may increase the number of times of selection of the label of “bicycle”, which is a similar label similar to “motorcycle”, by 1 point.

In step S312, the determination unit 227 determines whether all the annotation work has been completed. When all the annotation work has been completed (Yes in step S312), the processing of the annotation work support system 1C ends. When all the annotation work has not been completed (No in step S312), the process proceeds to step S313.

In step S313, the control unit 103 handles the region set as the second annotation region AR2 in the processing in step S307 as a new first annotation region AR1. For example, the control unit 103 handles the second annotation region AR2 of the second display image IM2 illustrated in FIG. 18 as a new first annotation region AR1. Furthermore, at this time, the control unit 103 handles, as the label set for the new first annotation region AR1, a label whose number of times of selection has increased in the processing of step S310 or step S311 and which is other than the similar label.

In step S314, the list display order update unit 226 updates the display order of the plurality of labels included in the label list LL according to the number of times of selection of each of the plurality of labels.

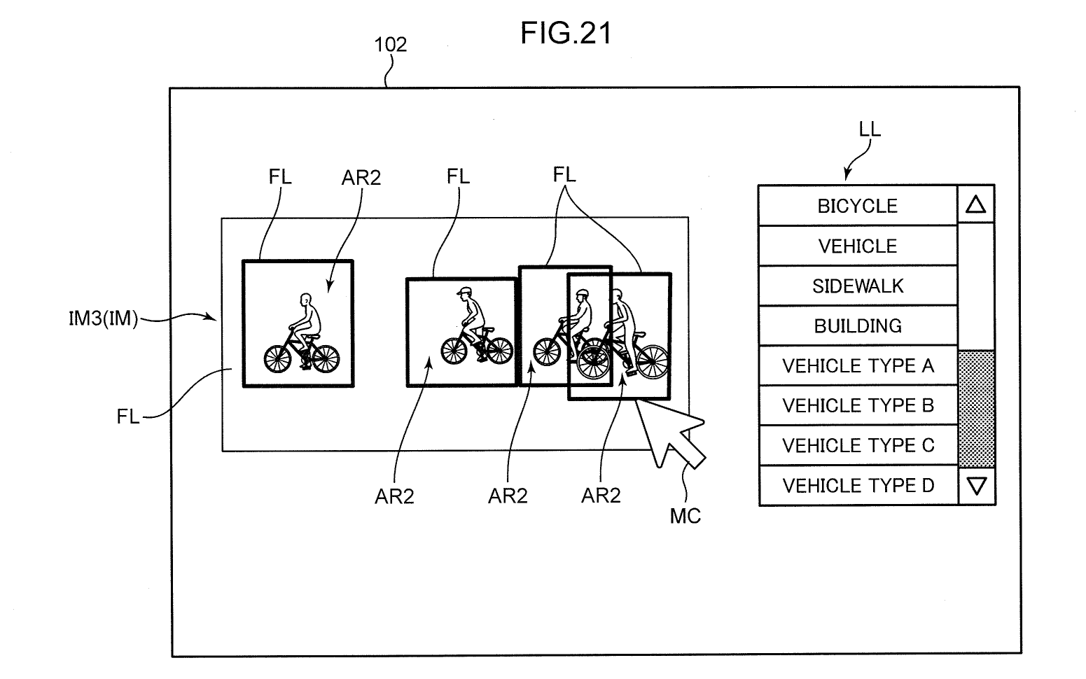

In step S315, the display control unit 223 displays the next image data IM and the label list LL after the display order change on the display device 102. For example, the display control unit 223 displays the third display image IM3 including four people riding bicycles as illustrated in FIG. 21.

Then, returning to step S307, the control unit 103 receives a new annotation instruction for the third display image IM3 from the worker, and sets a new second annotation region AR2 in the third display image IM3 based on the annotation instruction. For example, the control unit 103 sets each of the regions inside four quadrangular frames FL surrounding four bicycles as illustrated in FIG. 21 as a new second annotation region AR2.

Then, the process proceeds to step S308, and the region similarity evaluation unit 228 evaluates the region similarity between the first annotation region AR1 in the second display image IM2 and the four second annotation regions AR2 in the third display image IM3, and determines the third annotation region AR3. Hereinafter, the same processing is repeated until the determination unit 227 determines that the annotation work for all the image data IM has been completed.

According to the annotation work support system 1C of the third embodiment, in a case where the region similarity between the first annotation region AR1 and the second annotation region AR2 is high, for example, in a case where similar objects are included in the first annotation region and the second annotation, the number of times of selection of the label selected for the first annotation region AR1 increases. In this way, since the operation of selecting the label for the second annotation region is omitted, the annotation work is further simplified.

### Fourth Embodiment

In the third embodiment, an example in which the worker designates the upper left vertex and the lower right vertex of the first annotation region AR1 by operating the mouse in order to instruct the first annotation region AR1 in step S303 has been described. However, the first annotation region AR1 may be indicated by the point designation described above.

The configuration of the annotation work support system according to the fourth embodiment is the same as the configuration of the annotation work support system 1C according to the third embodiment. In addition, the flow of processing of the annotation work support system according to the fourth embodiment is similar to the flow of processing of the annotation work support system 1C according to the third embodiment. Therefore, the processing of the annotation work support system according to the fourth embodiment will be described below with reference to the flowchart illustrated in FIG. 16.

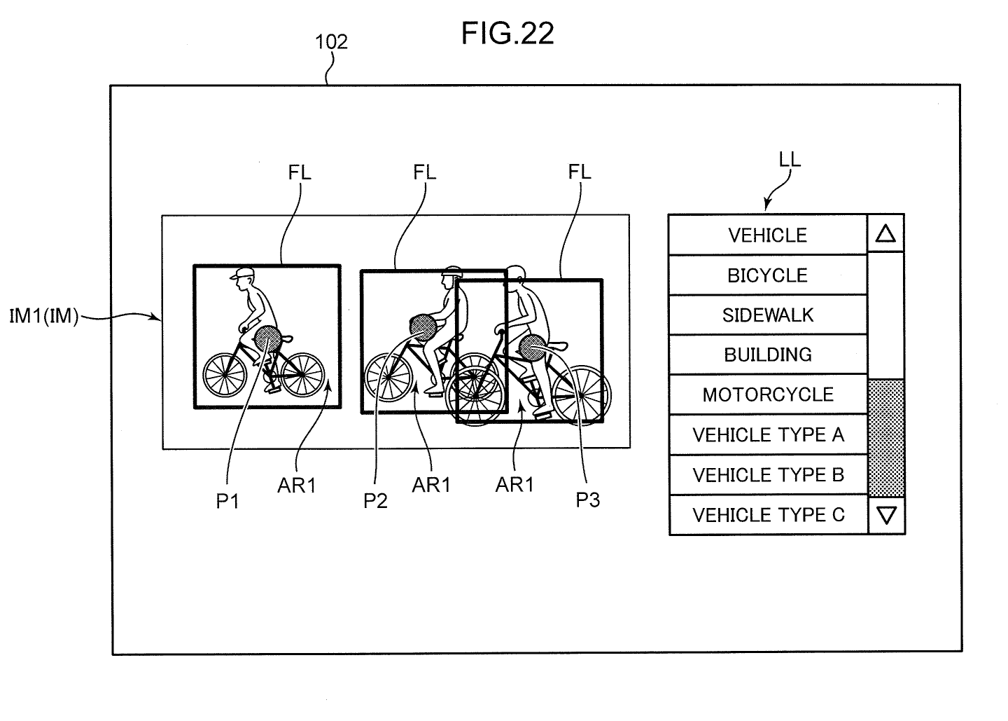

In step S301, the display control unit 223 causes the display device 102 to display the image data IM and the label list LL. For example, the display control unit 223 causes the display device 102 to display the first display image IM1 including three bicycles as illustrated in FIG. 22.

In step S302, the control unit 103 of the worker terminal 10 receives selection of a label for the first display image IM1. Here, it is assumed that the worker selects the label “bicycle”.

In step S303, the control unit 103 receives an annotation instruction for the first display image IM1, and sets the first annotation region AR1 in the first display image IM1 based on the annotation instruction. Specifically, the worker designates the position of the object as a point by clicking the mouse as the operation unit 101 while placing the mouse cursor MC on the portion indicated by the point P1 in FIG. 22. Similarly, the worker designates the position of the object by clicking the mouse while placing the mouse cursor MC on the portions indicated by the points P2 and P3. The region extraction unit 103A of the control unit 103 that has received such an operation recognizes pixels around the points P1, P2, and P3, and estimates the contour of each object specified by the worker. That is, the contour of each of the three bicycles is estimated. Then, the region extraction unit 103A surrounds the regions near the three bicycles by three quadrangular frames FL as illustrated in FIG. 22, and extracts the regions. The control unit 103 sets each of the regions extracted in this way as the first annotation region AR1.

According to the annotation work support system of the fourth embodiment, the instruction of the first annotation region AR1 is completed by designating the position of the object by a point. Therefore, the work of instructing the first annotation region AR1 is simplified as compared with the case of designating the upper left vertex and the lower right vertex of the first annotation region AR1 by operating the mouse. As a result, the annotation work is further simplified.

Modifications set forth below can be adopted in the present disclosure.

### Modification

(1) The present disclosure is also applicable to a case where target data is sound data, sentence data, or moving image data. That is, the present disclosure can also be applied to a case of performing annotation work of reproducing sound data as target data and setting labels such as “kitchen sound”, “living room sound”, “dog barking”, and “train sound” to the sound data. In this case, the display device 102 may have a built-in speaker, for example. Similarly, the present disclosure is also applicable to a case of performing annotation work of displaying sentence data as target data and setting labels such as “noun”, “verb”, “adverb”, and “conjunction” to each word constituting the sentence data. Furthermore, the present disclosure is also applicable to annotation work of setting a label for each piece of image data IM constituting moving image data.
(2) The selection of the label may be realized by inputting voice data to the control unit 103. For example, the worker terminal 10 may further include a microphone (not illustrated), and the control unit 103 may further include a voice recognition unit (not illustrated). In this case, the worker utters words such as “bicycle”, “motorcycle”, or “person” toward the microphone. These voices are recognized by the voice recognition unit of the control unit 103, and a label corresponding to the voice uttered by the worker is specified. Then, the specified label is selected as a label set in the image data IM or the like.

In addition, selection of a label may be realized by inputting text data to the control unit 103. For example, a text box for inputting characters may be further displayed on the display device 102 of the worker terminal 10, and the worker may input characters such as “bicycle” in the text box. In this case, the control unit 103 specifies a label corresponding to the characters input by the worker, and the specified label is selected as a label set in the image data IM or the like.

According to this configuration, since it is possible to select a label by voice data or text data, it is not necessary for a worker to manually select an appropriate label. As a result, the annotation work becomes further simplified.

In addition, when selection of a label by voice data or text data is received, the number of times of selection recorded in the input history may be reset. That is, the display order of the labels may be reset once. As a result, in the subsequent annotation work, the display order of the labels is easily updated, so that the display order of the labels can be easily updated to an appropriate order. As a result, the annotation work is further simplified.

(3) The image similarity evaluation unit 221 and the image display order update unit 222 are not essential. For example, a worker may create in advance the image data set IMS including a plurality of pieces of image data IM similar to each other.

(4) When there is a label whose position displayed by the processing of the list display order update unit 226 has moved to the upper portion of the label list LL, the control unit 103 may change the background color of the cell storing the label. Alternatively, the control unit 103 may change the color of the character indicating the label. Alternatively, the control unit 103 may bold the characters indicating the label. Alternatively, the control unit 103 may blink characters indicating the label. Alternatively, the control unit 103 may make the size of the cell storing the label larger than the size of the cell storing other labels. In this way, the label moved to the upper portion of the label list LL can be made conspicuous. As a result, the label selection work of the user can be further simplified.

(5) In the third embodiment and the fourth embodiment, an example in which the processor 220 does not include the image similarity evaluation unit 221 and the image display order update unit 222 has been described, but the processor 220 may include these functional units. That is, in the third embodiment and the fourth embodiment, the image data set IMS may be rearranged based on the image similarity.

(6) In each of the above embodiments, an example of setting a label to an object included in the image data IM has been described. However, the label may be set to an area included in the image data IM.

The present disclosure is useful in the technical field of supporting annotation work.

1. An information processing method in an information processing device, comprising:
displaying target data and a label list including a plurality of labels for classifying the target data on a worker terminal;
receiving selection of one of the plurality of labels;
updating an input history in which a number of times of selection of each of the plurality of labels is recorded based on a selection result of the label; and
updating a display order of the plurality of labels included in the label list according to a number of times of selection recorded in the input history each time display of the target data is switched to next target data.

2. The information processing method according to claim 1, wherein
the target data is image data,
the method further comprises receiving an annotation instruction for the image data, and
the label is selected to classify an object included in an annotation region corresponding to the annotation instruction.

3. The information processing method according to claim 2, wherein
the target data includes first image data and second image data displayed after the first image data,
the method further comprises determining a third annotation region among one or more first annotation regions set in the first image data, the third annotation region having a region similarity exceeding a first threshold with respect to one or more second annotation regions set in the second image data, and
the updating of the input history includes increasing a number of times of selection of a label selected for the one or more first annotation regions according to a number of the third annotation regions.

4. The information processing method according to claim 2, wherein
the annotation instruction can designate one or more annotation regions for one label, and
the updating of the input history includes increasing the number of times of selection of the one label according to the number of the annotation regions designated for the one label.

5. The information processing method according to claim 1, wherein the updating of the input history includes increasing a number of times of selection of a selected label and a number of times of selection of a similar label similar to the selected label.

6. The information processing method according to claim 2, wherein a display order of the target data is determined in descending order of image similarity to target data displayed immediately before.

7. The information processing method according to claim 6, further comprising resetting the number of times of selection recorded in the input history when the image similarity is equal to or less than a second threshold.

8. The information processing method according to claim 2, wherein the annotation region is a polygon surrounding the object or a contour of the object.

9. The information processing method according to claim 1, wherein the receiving of selection of the label includes inputting of voice data or text data.

10. The information processing method according to claim 9, further comprising resetting, when the selection of the label based on the voice data or the text data is received, the number of times of selection recorded in the input history.

11. The information processing method according to claim 2, wherein
the annotation instruction is an instruction to designate a position of the object by a point, and
the method further comprises extracting the object from the image data based on the position of the point, and setting the annotation region to the object.

12. An information processing device comprising:
a display control unit that displays target data and a label list including a plurality of labels for classifying the target data on a worker terminal;
a reception unit that receives selection of one of the plurality of labels;
a history update unit that updates an input history in which a number of times of selection of each of the plurality of labels is recorded based on a selection result of the label; and
an order update unit that updates a display order of the plurality of labels included in the label list according to a number of times of selection recorded in the input history each time display of the target data is switched to next target data.

13. A non-transitory computer readable recording medium storing an information processing program for causing a processor to execute:
displaying target data and a label list including a plurality of labels for classifying the target data on a worker terminal;
receiving selection of one of the plurality of labels;
updating an input history in which a number of times of selection of each of the plurality of labels is recorded based on a selection result of the label; and
updating a display order of the plurality of labels included in the label list according to a number of times of selection recorded in the input history each time display of the target data is switched to next target data.
